(19) United States
(12) Patent Application Publication
(10) Pub. No.: US 2025/0322447 A1
(43) Pub. Date: Oct. 16, 2025

(54) MAPS VIEWPORT OPTIMIZATION SYSTEM

(71) Applicant: Airbnb, Inc., San Francisco, CA (US)

(72) Inventors: Malay Haldar, Foster City, CA (US); Hongwei Zhang, Saratoga, CA (US); Pavan Tapadia, San Mateo, CA (US); Sherry Therese Chen, San Mateo, CA (US); Kedar Bellare, San Jose, CA (US); Soumyadip Banerjee, Burlingame, CA (US); Xiaotang Wang, San Francisco, CA (US)

(21) Appl. No.: 18/631,644

(22) Filed: Apr. 10, 2024

(51) Int. Cl. G06Q 30/0601; G06Q 10/02

(52) U.S. Cl. CPC G06Q 30/0643; G06Q 10/02

(57) ABSTRACT

Systems and methods are provided to select a set of candidate listings having geographic locations within a geographical area, fit a bound for a maps viewport to the set of candidate listings, generate a maximum score for the set of candidate listings based on a booking probability for each listing, a distance of the listing location from a center of the bound for the maps viewport, and visibility based on other listings. The systems and methods further optimize the listings shown in the maps viewport by removing and replacing farthest listings up to a predefined number of listings to be removed and computing a cumulative booking score for each set of listings to compare to the maximum score. The systems and methods cause display in a maps viewport in a user interface of a computing device of a set of listings that has a maximum score.

### BACKGROUND

An online marketplace may provide a number of services, such as accommodations, tours, transportation and the like, and allow users to reserve or “book” one or more services. For example, a first user (e.g., host) can list one or more services on the online marketplace and a second user (e.g., guest) can request to view listings of services for a particular location (e.g., San Francisco) that may include a listing for the first user's service. The view of the listings is typically provided in a list form and/or on a map.

### BRIEF DESCRIPTION OF THE DRAWINGS

Various ones of the appended drawings merely illustrate example embodiments of the present disclosure and should not be considered as limiting its scope.

FIG. 1 is a block diagram illustrating a networked system, according to some examples.

FIG. 2 is a block diagram illustrating a reservation system, according to some examples.

FIG. 3 illustrates an example user interface for a description of a listing for a trip item, according to some examples.

FIG. 4 is a flow chart illustrating aspects of a method, according to some examples.

FIGS. 5-8 illustrate examples of a maps viewport, according to some examples.

FIG. 9 is a block diagram illustrating an example of a software architecture that may be installed on a machine, according to some examples.

FIG. 10 illustrates a diagrammatic representation of a machine, in the form of a computer system, within which a set of instructions may be executed for causing the machine to perform any one or more of the methodologies discussed herein, according to some examples.

FIG. 11 illustrates an example maps viewport, according to some examples.

### DETAILED DESCRIPTION

Systems and methods described herein relate to a maps viewport optimization system. As explained above, a user can request to view listings in an online marketplace. These listings are typically provided on a device of the user in a list form and/or on a map. A system typically uses a ranking system to provide search results in an order relevant to the user, to provide higher quality results first, or the like. Ranking an order of search results in a list format, however, breaks down for a maps format. For example, since a map view of listings is shown by location, the ranked order of listings is not reflected. Indeed, ranking itself is irrelevant for map results as there is no sequential list involved. Thus, one technical problem is how to determine what listings should be displayed and how they should be displayed on a map when ranking is irrelevant.

Transitioning from a list format to a map format in a user interface can lead to technical problems, particularly concerning the waste of resources when the ranking of listings is not preserved. In a list format, users often benefit from a clear, ordered presentation of options, typically sorted by relevance, price, rating, or other criteria. This ranking helps users make informed decisions efficiently. However, when switching to a map view, this ordered structure can be lost if the system does not have the capability to maintain or represent the ranking spatially. The absence of visible ranking in the map view can lead to users spending additional time and effort trying to discern the quality or relevance of each listing, as they may have to click on each individual map marker to retrieve the information that was previously visible at a glance in the list format. This inefficiency not only frustrates users but also increases the computational load on the system, as it has to handle more requests and data retrieval operations than necessary.

Furthermore, the lack of ranking integration into the map view can result in users overlooking top-ranked listings simply because they do not stand out on the map. This can lead to suboptimal choices and a poor user experience. From the service provider's perspective, it can also mean that higher-quality or more profitable listings receive less attention than they would in a list format, potentially affecting conversion rates and revenue. Additionally, the computational effort required to switch between views and to reprocess the data to fit different formats can strain server resources, especially if many users frequently toggle between list and map views expecting to retain the ranking order. This strain is exacerbated during peak usage times, leading to slower response times and increased server costs. In essence, the technical challenge lies in designing a map interface that can effectively convey the ranking of listings without losing the spatial context that makes the map view beneficial. Without addressing this issue, the transition between list and map views can lead to inefficient use of both user time and system resources, undermining the overall functionality of the service.

Another technical problem is how to measure user attention when presented with a number of listings in a map viewport. In some cases, user attention improves with less listings shown in a maps viewport and based on where the listings are shown within the viewport.

Accordingly, a maps viewport optimization system is described herein that dynamically customizes, in real time or near real time (e.g., in response to a request to view listings or to a zoom or drag of a map viewport) how listings are displayed in a maps viewport to improve the quality and visibility of listings shown in a map format to address at least the above technical problems. Ranking of search results still plays a crucial role in selection of top listings for display from all listings available in a map area. But once the top listings are selected, their relative ordering is irrelevant. Thus, in addition to ranking and selection of top listings, example embodiments consider both visibility and distance of the listings to determine what listings should be displayed and how those listings should be displayed to improve the quality and visibility in a maps format.

For example, the maps viewport optimization system selects a set of candidate listings that include a top predefined number of listings from a plurality of listings having geographic locations within the a geographical area. The maps viewport optimization system fits a bound for the maps viewport to the set of candidate listings and generates a maximum score for the set of candidate listings based on a booking probability for each listing, a distance of the listing from a center of the bound for the maps viewport, and visibility based on other listings.

The maps viewport optimization system calculates a distance from each listing location to each other listing location in the set of candidate listings and optimizes the listings to be shown in the maps viewport by performing, for a maximum of a predefined number of listings removed, the following operations. The maps viewport optimization system removes, from the set of candidate listings, a listing with a largest distance to all other listings, fits a new bound for the maps viewport that includes a remaining set of candidate listings without the removed listing, replaces the removed listing with a new listing that has a geographical location within the new bound for the maps viewport to generate an updated set of candidate listings that includes the remaining set of candidate listings and the new listing, calculates a cumulative booking score for the updated set of candidate listings, determines whether the cumulative booking score for the updated set listings is greater than the maximum score, and based on determining that the new cumulative booking score for the updated set of candidate listings is greater than the maximum score, setting the maximum score to the new cumulative booking score. The maps viewport optimization system causes display in the map viewport in the user interface of the computing device of a set of listings that has the maximum score.

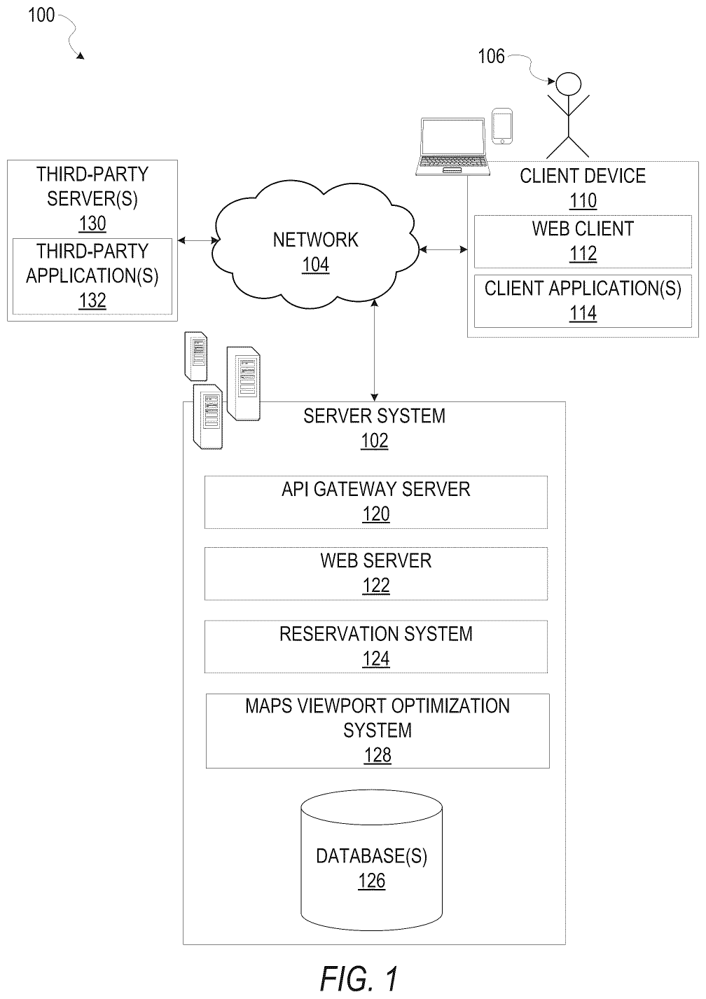

FIG. 1 is a block diagram illustrating a networked system 100, according to some example embodiments. The networked system 100 can include one or more computing devices such as a client device 110. The client device 110 may comprise, but is not limited to a mobile phone, desktop computer, laptop, portable digital assistant (PDA), smart phone, tablet, ultrabook, netbook, laptop, multiprocessor system, microprocessor-based or programmable consumer electronic system, game console, set-top box, computer in a vehicle, wearable device (e.g., smart watch, smart glasses), or any other communication device that a user may utilize to access the networked system 100. In some embodiments, the client device 110 comprises a display component (not shown) to display information (e.g., in the form of user interfaces). In further embodiments, the client device 110 comprises one or more of touch screens, accelerometers, gyroscopes, cameras, microphones, Global Positioning System (GPS) devices, and so forth. The client device 110 may be a device of a user that is used to request and receive reservation information, accommodation information, entry and access information for a reserved accommodation, set or update user preferences, request to view listings, view listings results in a list form or in a maps viewport, and so forth, associated with travel or other products or services. The client device 110 may also be a device of a user that is used to post and maintain a listing for a service, request and receive reservation information and guest information, generate entry and access information (e.g., access codes), set or update user preferences, and so forth.

One or more users 106 may be a person (e.g., guest, host, service personnel, customer support agent), a machine, or other means of interacting with the client device 110. In example embodiments, the user 106 may not be part of the networked system 100 but may interact with the networked system 100 via the client device 110 or other means. For instance, the user 106 can provide input (e.g., voice input, touch screen input, alphanumeric input) to the client device 110 and the input may be communicated to other entities in the networked system 100 (e.g., third-party servers 130, a server system 102) via a network 104. In this instance, the other entities in the networked system 100, in response to receiving the input from the user 106, can communicate information to the client device 110 via the network 104 to be presented to the user 106. In this way, the user 106 can interact with the various entities in the networked system 100 using the client device 110.

The networked system 100 may further include a network 104. One or more portions of the network 104 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the internet, a portion of the public switched telephone network (PSTN), a cellular telephone network, a wireless network, a Wi-Fi network, a WiMAX network, another type of network, or a combination of two or more such networks.

One or more portions of the network 104 may comprise short-range wireless communication, such as Bluetooth, WiFi, near field communication (NFC), ultraband, Zigbee, or other form of short-range wireless communication.

The client device 110 can access the various data and applications provided by other entities in the networked system 100 via a web client 112 (e.g., a browser, such as the Internet Explorer® browser developed by Microsoft® Corporation of Redmond, Washington) or one or more client applications 114. The client device 110 can include one or more client applications 114 (also referred to as “apps”) such as, but not limited to, a web browser, a messaging application, an electronic mail (email) application, an ecommerce site application, a mapping or location application, a reservation application, an entry or keypad access application, a customer support application, and the like.

In some embodiments, one or more client applications 114 can be included in a given one of the client devices 110 and configured to locally provide the user interface and at least some of the functionalities, with the client application 114 configured to communicate with other entities in the networked system 100 (e.g., third-party servers 130, the server system 102), on an as-needed basis, for data and/or processing capabilities not locally available (e.g., to access reservation or listing information, request data, authenticate a user 106, verify a method of payment, receive an access code). Conversely, one or more client applications 114 may not be included in the client device 110, and then the client device 110 can use its web browser to access the one or more applications hosted on other entities in the networked system 100 (e.g., third-party servers 130, the server system 102).

The networked system 100 can further include one or more third-party servers 130. The one or more third-party servers 130 may include one or more third-party application(s) 132. The one or more third-party application(s) 132, executing on the third-party server(s) 130, may interact with the server system 102 via a programmatic interface provided by an application programming interface (API) gateway server 120. For example, one or more of the third-party applications 132 can request and utilize information from the server system 102 via the API gateway server 120 to support one or more features or functions on a website hosted by a third party or an application hosted by the third party. The third-party website or application 132, for example, can provide various functionality that is supported by relevant functionality and data in the server system 102, such as entry and access information for an accommodation. The third-party servers 130 can be a cloud computing environment, according to some example embodiments. The third-party servers 130, and any servers associated with the third-party servers 130, can be associated with a cloud-based application, in one example embodiment.

The server system 102 can provide server-side functionality via the network 104 (e.g., the internet or a WAN) to one or more third-party servers 130 and/or one or more client devices 110 and/or one or more accommodation devices 140. The server system 102 is a cloud computing environment, according to some example embodiments. The server system 102, and any servers associated with the server system 102, are associated with a cloud-based application, in one example embodiment.

In one example, the server system 102 provides server-side functionality for an online marketplace. The online marketplace may provide various listings for trip items, such as accommodations hosted by various managers (also referred to as “owners” or “hosts”) that can be reserved by clients (also referred to as “users” or “guests”), such as an apartment, a house, a cabin, one or more rooms in an apartment or house, and the like. As explained above, the online marketplace can further provide listings for other trip items, such as experiences (e.g., local tours), car rentals, flights, public transportation, and other transportation or activities related to travel.

The server system 102 can include the API gateway server 120, a web server 122, a reservation system 124 and a maps viewport optimization system 128 that may be communicatively coupled with one or more databases 126 or other forms of data store.

The one or more databases 126 may be one or more storage devices that store data related to the reservation system 124, the maps viewport optimization system 128, and other systems or data. The one or more databases 126 may further store information related to third-party servers 130, third-party applications 132, client devices 110, client applications 114, users 106, and so forth. The one or more databases 126 may be implemented using any suitable database management system such as MySQL, PostgreSQL, Microsoft SQL Server, Oracle, SAP, IBM DB2, or the like. The one or more databases 126 may include cloud-based storage in some embodiments.

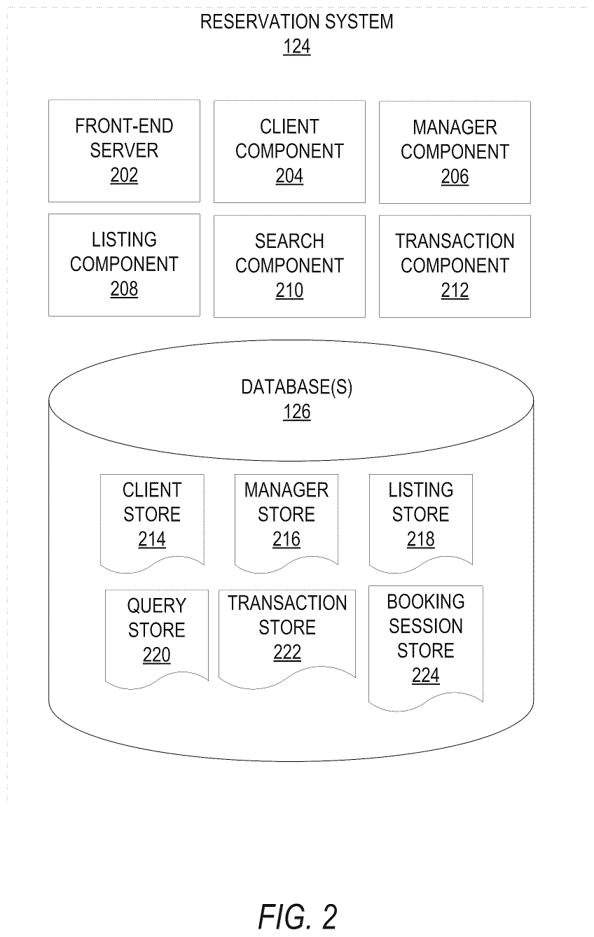

The reservation system 124 manages resources and provides back-end support for third-party servers 130, third-party applications 132, client applications 114, and so forth, which may include cloud-based applications. The reservation system 124 provides functionality for viewing listings related to trip items (e.g., accommodation listings, activity listings), generating and posting a new listing, analyzing and ranking images to be posted in a new listing, managing listings, booking listings and other reservation functionality, and so forth, for an online marketplace. Further details related to the reservation system 124 are shown in FIG. 2.

FIG. 2 is a block diagram illustrating a reservation system 124, according to some example embodiments. The reservation system 124 comprises a front-end server 202, a client component 204, a manager component 206, a listing component 208, a search component 210, and a transaction component 212. The one or more database(s) 126 include a client store 214, a manager store 216, a listing store 218, a query store 220, a transaction store 222, and a booking session store 224. The reservation system 124 may also contain different and/or other components that are not described herein.

The reservation system 124 may be implemented using a single computing device or a network of computing devices, including cloud-based computer implementations. The computing devices may be server-class computers including one or more high-performance computer processors and random access memory, which may run an operating system such as Linux or the like. The operations of the reservation system 124 may be controlled either through hardware or through computer programs installed in nontransitory computer-readable storage devices such as solid-state devices or magnetic storage devices and executed by the processors to perform the functions described herein.

The front-end server 202 includes program code that allows client devices 110 to communicate with the reservation system 124. The front-end server 202 may utilize the API gateway server 120 and/or the web server 122 shown in FIG. 1. The front-end server 202 may include a web server hosting one or more websites accessible via a hypertext transfer protocol (HTTP), such that user agents, such as a web browser software application, may be installed on the client devices 110 and can send commands to and receive data from the reservation system 124. The front-end server 202 may also utilize the API gateway server 120 that allows software applications installed on client devices 110 and third-party servers 130 and applications 132 to call to the API to send commands to and receive data from the reservation system 124. The front-end server 202 further includes program code to route commands and data to the other components of the reservation system 124 to carry out the processes described herein and respond to the client devices 110 accordingly.

The client component 204 comprises program code that allows clients (also referred to herein as “users” or “guests”) to manage their interactions with the reservation system 124 and executes processing logic for client-related information that may be requested by other components of the reservation system 124. Each client is represented in the reservation system 124 by an individual client object having a unique client identifier (ID) and client profile, both of which are stored in the client store 214.

The client profile includes a number of client-related attribute fields that may include a profile picture and/or other identifying information, a geographical location, a client calendar, an access code, smart device preferences (e.g., user preferences), and so forth. The client's geographical location is either the client's current location (e.g., based on information provided by the client device 110) or the client's manually entered home address, neighborhood, city, state, or country of residence. The client location may be used to filter search criteria for time-expiring inventory relevant to a particular client or to assign default language preferences.

The client component 204 provides code for clients to set up and modify the client profile. The reservation system 124 allows each client to exchange communications, request transactions, and perform transactions with one or more managers.

The manager component 206 comprises program code that provides a user interface that allows managers (also referred to herein as “users,” “hosts” or “owners”) to manage their interactions and listings with the reservation system 124 and executes processing logic for manager-related information that may be requested by other components of the reservation system 124. Each manager is represented in the reservation system 124 by an individual manager object having a unique manager ID and manager profile, both of which are stored in the manager store 216.

The manager profile is associated with one or more listings owned or managed by the manager and includes a number of manager attributes including transaction requests and a set of listing calendars for each of the listings managed by the manager.

The manager component 206 provides code for managers to set up and modify the manager profile listings. A user 106 of the reservation system 124 can be both a manager and a client. In this case, the user 106 will have a profile entry in both the client store 214 and the manager store 216 and be represented by both a client object and a manager object. The reservation system 124 allows the manager to exchange communications, respond to requests for transactions, and conduct transactions with other managers.

The listing component 208 comprises program code for managers to list trip items, such as time-expiring inventory, for booking by clients. The listing component 208 is configured to receive the listing from a manager describing the inventory being offered; a timeframe of its availability including one or more of the start date, end date, start time, and an end time; a price; a geographical location; images and descriptions that characterize the inventory; and any other relevant information. For example, for an accommodation reservation system, a listing may include a type of accommodation (e.g., house, apartment, room, sleeping space, or other), a representation of its size (e.g., square footage, number of rooms), the dates that the accommodation is available, and a price (e.g., per night, per week, per month). The listing component 208 allows a user 106 to include additional information about the inventory, such as videos, photographs, and other media, or such as accessibility and other information.

The geographical location associated with the listing identifies the complete address, neighborhood, city, and/or country of the offered listing. The listing component 208 is also capable of converting one type of location information (e.g., mailing address) into another type of location information (e.g., country, state, city, neighborhood) using externally available geographical map information.

The price of the listing is the amount of money a client needs to pay in order to complete a transaction for the inventory. The price may be specified as an amount of money per day, per week, per month, and/or per season, or per another interval of time specified by the manager. Additionally, the price may include additional charges such as cleaning fees, pet fees, service fees, and taxes, or the listing price may be listed separately from additional charges.

Each listing is represented in the reservation system 124 by a listing object, which includes the listing information as provided by the manager and a unique listing ID, both of which are stored in the listing store 218. Each listing object is also associated with the manager object for the manager providing the listing.

Each listing object has an associated listing calendar. The listing calendar stores the availability of the listing for each time interval in a period (each of which may be thought of as an independent item of time-expiring inventory), as specified by the manager or determined automatically (e.g., through a calendar import process). For example, a manager may access the listing calendar for a listing, and manually indicate the time intervals for which the listing is available for transaction by a client, which time intervals are blocked as not available by the manager, and which time intervals are already in transaction (e.g., booked) for a client. In addition, the listing calendar continues to store historical information as to the availability of the listing identifying which past time intervals were booked by clients, blocked, or available. Further, the listing calendar may include calendar rules (e.g., the minimum and maximum number of nights allowed for the inventory, a minimum or maximum number of nights needed between bookings, a minimum or maximum number of people allowed for the inventory). Information from each listing calendar is stored in the listing store 218.

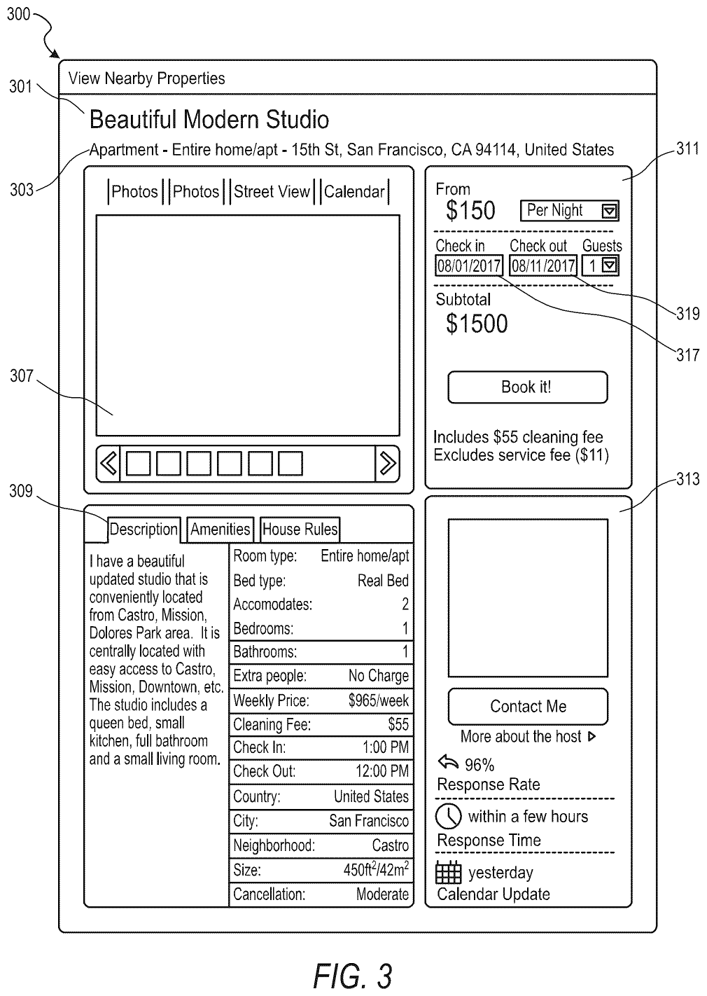

FIG. 3 illustrates an example user interface 300 for a description of a listing for a trip item (e.g., an apartment in San Francisco) in an online marketplace. The example listing shown in FIG. 3 is for accommodations in San Francisco. In other examples, the listing could be for a tour, local experience, transportation service, or other trip item. The listing may include a title 301 and a brief description 303 of the trip item. The listing may further include photos of the trip item, maps of the area or a location associated with the trip item, a street view of the trip item, a calendar for the trip item, and so forth, which may be viewed in area 307. The listing may include a detailed description 309, pricing information 311, and the listing host's information 313. The listing may further allow a user to select a date range for the trip item by entering or choosing specific check-in date 317 and check-out date 319.

Returning to FIG. 2, the search component 210 comprises program code configured to receive an input search query from a client and return a set of time-expiring inventory and/or listings that match the input query. Search queries are saved as query objects stored by the reservation system 124 in the query store 220. A query may contain a search location, a desired start time/date, a desired duration, a desired listing type, and a desired price range, and may also include other desired attributes or features of the listing. A potential client need not provide all the parameters of the query listed above in order to receive results from the search component 210. The search component 210 provides a set of time-expiring inventory and/or listings in response to the submitted query to fulfill the parameters of the submitted query. The online system may also allow clients to browse listings without submitting a search query, in which case the viewing data recorded will only indicate that a client has viewed the particular listing without any further details from the submitted search query. Upon the client providing input selecting a time-expiring inventory/listing to more carefully review for possible transaction, the search component 210 records the selection/viewing data indicating which inventory/listing the client viewed. This information is also stored in the query store 220.

The transaction component 212 comprises program code configured to enable clients to submit a contractual transaction request (also referred to as a formal request) to transact for time-expiring inventory. In operation, the transaction component 212 receives a transaction request from a client to transact for an item of time-expiring inventory, such as a particular date range for a listing offered by a particular manager. A transaction request may be a standardized request form that is sent by the client, which may be modified by responses to the request by the manager, either accepting or denying a received request form, such that agreeable terms are reached between the manager and the client. Modifications to a received request may include, for example, changing the date, price, or time/date range (and thus, effectively changing which time-expiring inventory is being transacted for). The standardized form may require the client to record the start time/date, duration (or end time), or any other details that must be included for an acceptance to be binding without further communication.

The transaction component 212 receives the filled-out form from the client and, in one example, presents the completed request form including the booking parameters to the manager associated with the listing. The manager may accept the request, reject the request, or provide a proposed alternative that modifies one or more of the parameters. If the manager accepts the request (or the client accepts the proposed alternative), then the transaction component 212 updates an acceptance status associated with the request and the time-expiring inventory to indicate that the request was accepted. The client calendar and the listing calendar are also updated to reflect that the time-expiring inventory has been transacted on for a particular time interval. Other components not specifically described herein allow the client to complete payment and the manager to receive payment.

The transaction component 212 may further comprise code configured to enable clients to instantly book a listing, whereby the online marketplace books or reserves the listing upon receipt of the filled-out form from the client.

The transaction store 222 stores requests made by clients. Each request is represented by a request object. The request includes a timestamp, a requested start time, and a requested duration or reservation end time. Because the acceptance of a booking by a manager is a contractually binding agreement with the client that the manager will provide the time-expiring inventory to the client at the specified times, all the information that the manager needs to approve such an agreement is included in the request. A manager response to a request comprises a value indicating acceptance or denial and a timestamp. Other models may allow for instant booking, as mentioned above.

The transaction component 212 may also provide managers and clients with the ability to exchange informal requests to transact. Informal requests are not sufficient to be binding upon the client or manager if accepted, and, in terms of content, may vary from mere communications and general inquiries regarding the availability of inventory, to requests that fall just short of whatever specific requirements the reservation system 124 sets forth for formal transaction requests. The transaction component 212 may also store informal requests in the transaction store 222, as both informal and formal requests provide useful information about the demand for time-expiring inventory.

The booking session store 224 stores booking session data for all booking sessions performed by clients. Booking session data may include details about a listing that was booked and data about one or more other listings that were viewed (or seriously considered) but not booked by the client before booking the listing. For example, once a listing is booked, the transaction component 212 may send data about the listing or the transaction, viewing data that was recorded for the booking session, and so forth, to be stored in the booking session store 224. The transaction component 212 may utilize other components or data stores to generate booking session data to be stored in the booking session store 224.

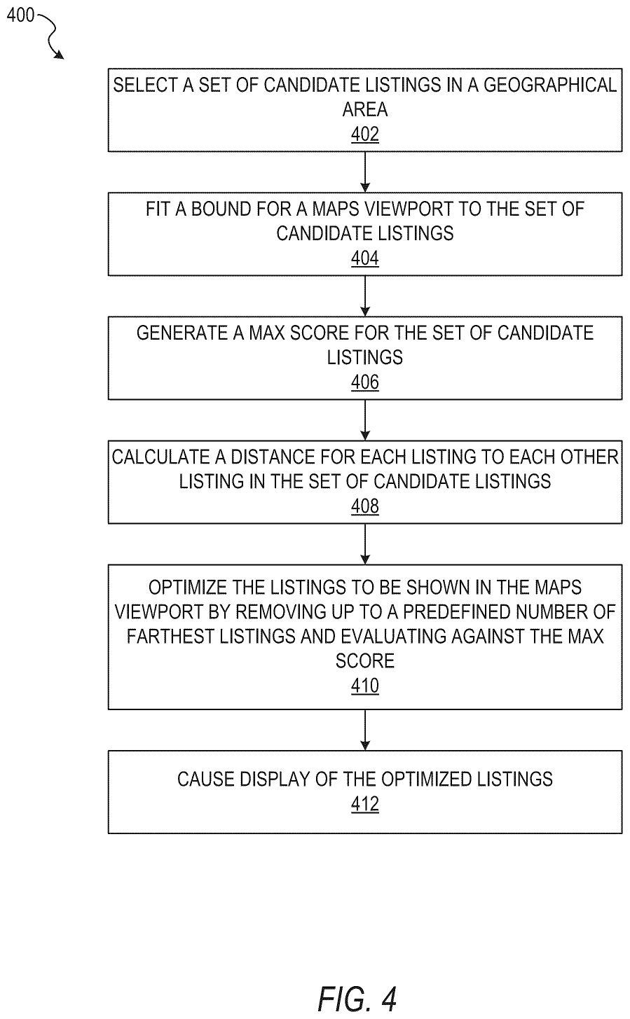

FIG. 4 is a flowchart illustrating aspects of a method 400 for optimizing listings in a maps viewport, according to some example embodiments. For illustrative purposes, the method 400 is described with respect to the networked system 100 of FIG. 1. It is to be understood that the method 400 may be practiced with other system configurations in other embodiments.

In operation 402, a computing system (e.g., server system 102, reservation system 124, or maps viewport optimization system 128) selects a set of candidate listings in a geographical area. For example, a user can provide input, via a user interface on a computing device (e.g., client device 110) to request listings in a geographical area or to change an area viewable in a map viewport that is displaying requested listings. For instance, the user can search for listings in San Francisco or other geographic location to be displayed in a map viewport on the user interface. In another example, after the listings are displayed on a map viewport in the user interface, the user can drag the map to move it or zoom in or out on the map via a touchscreen, mouse, or other input mechanism. The computing system receives or detects the input indicating the change in geographical area for the maps viewport displayed on the user interface. The computing system selects a set of candidate listings that include a top predefined number of listings from a plurality of listings having geographic locations within the geographical area or the changed geographical area.

For instance, a map of San Francisco may be displayed in a map viewport on the user interface of the computing device. There may be hundreds or thousands of listings in San Francisco. The computing system determines which listings have a geographic location within the geographical area or changed geographical area of the maps viewport and the selects a predefined number of the most relevant listings (e.g., a top predefined number of listings). In some examples, the computing system determines which listing are the top or most relevant listings based on a booking probability (e.g., a probability that a given listing will be booked) for each listing. The booking probability for each listing is based on at least one of: the listing price, listing location, past user engagement such as booking, reviews, cancellations, request rejected and the like for the listing, or various quality signals such as amenities, beds, bedrooms, details about the host, and so on. In one example, a machine learning model is trained on booking and listing data to analyze features, such as at least one of: the listing price, listing location, past user engagement such as booking, reviews, cancellations, request rejected and the like for the listing, or various quality signals such as amenities, beds, bedrooms, details about the host, and so on, to be configured to generate a booking probability.

In one example, the listings are ranked by booking probability (e.g., booking probability score) and the computing system selects a predefined number of the top ranked listings of the listings having a geographic location within the geographic area or changed geographic area of the maps viewport. In one example the predefined number of listings is between 10 and 18 listings.

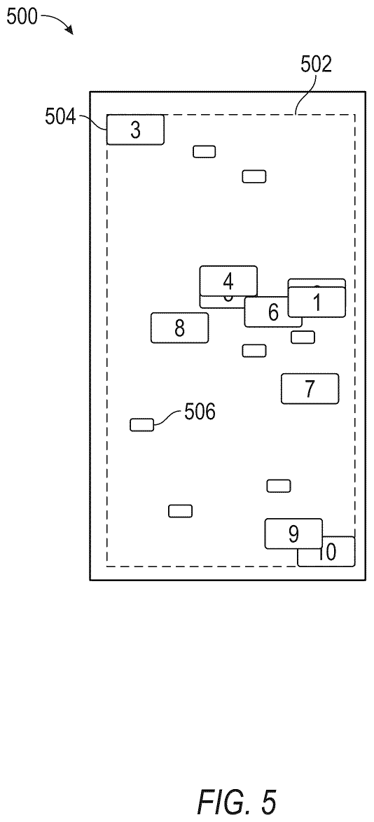

In operation 404, the computing system fits a bound for the maps viewport to the set of candidate listings. In one example, the bound is a smallest boundary that can include all of the listings in the set of candidate listings. In this way, the listings can be the most visible possible in the maps viewport. In some examples, this smallest boundary is adjusted based on the display size or shape of a computing device. For example, on an iPhone with a rectangular display, additional areas can be padded to give a final display a rectangular shape. FIG. 5 illustrates an example maps viewport 500 that has a bound 502 fit to the set of candidate listings. The candidate listings in the example maps viewport 500 are represented by graphical icons 1 through 10. These graphical icons, such as graphical icon 3 (504), are also referred to herein as price pins and are of a first size. As an option, graphical icons in a second (smaller) size, such as graphical icon 506, can also be included in the maps viewport. In the example maps viewport 500, in addition to the graphical icons of the first size 1 through 10, there are seven graphical icons of the second (smaller) size. These smaller graphical icons, such as graphical icon 506, are also referred to herein as mini-pins. Mini-pins represent low relevant listings in the geographical area represented by the maps viewport 500.

Returning to FIG. 4, in operation 406, the computing system generates a maximum score for the set of candidate listings based on a booking probability for each listing, a distance of the listing from a center of the bound for the maps viewport, and a visibility based on other listings. In one example, the maximum score is set based on calculating a cumulative booking score for the set of candidate listings. In some examples, the cumulative booking score can be represented by the one of the following formulas:

$$\text{?}$$

$$\text{?} \text{indicates text missing or illegible when filed}$$

Each of these formulas calculates a cumulative booking score for a set of N listings (e.g., the set of candidate listings) based on whether each of the listings are visible, a booking probability score for each listing and a distance of a listing from a center of the maps viewport (e.g., discount).

Whether a listing is visible is determined based on whether a map pin (e.g., larger graphical icon or price pin) is atop a cluster of pins, and thus visible, or hidden beneath other pins, making it difficult to see directly. The booking probability score for each listing is discussed above and is multiplied by the discount which give less attention to a listing that is further a way from the center of the maps viewport, since the further away from the center, the less user attention it will get.

The distance of a listing from a center of the maps viewport is represented by the discount portion of the algorithm. In analyzing viewing data, the inventors discovered that user attention typically focuses on the center of a maps viewport. Thus, a distance of a listing from a center of the maps viewport helps to generate top listings that are more centered in the maps viewport to attract more user attention.

The maximum score is initially set to the cumulative booking score for the candidate set of listings and used to evaluate various optimized versions of listings (sets of listings) to be included in the maps viewport, as described next.

In operation 408, the computing system calculates a distance from each listing location to each other listing location in the set of candidate listings. For example, the computing system can use an Euclidean distance formula or other means for calculating a distance between two points (e.g., a location of a first listing and a location of a second listing) in space. Some other examples of calculating a distance include using the latitude and longitude of two listings as cartesian coordinates, and determining the distance between these two points. Another example would be to take into account the angles implied by the latitude and longitude, and compute the distance factoring in the curvature of earth, which is useful for large distances.

In operation 410, the computing system optimizes the listings to be shown in the maps viewport by evaluating different sets of candidate listings using the cumulative booking score and maximum score. To do this, the computing system first determines a farthest listing in the set of candidate of listings which is the listing that has the biggest distance to all other listings in the candidate set of candidate listings. The computing system removes, from the set of candidate listings, the listing that is the farthest listing and then fits a new bound for the map viewport that includes a remaining set of candidate listings without the removed listing.

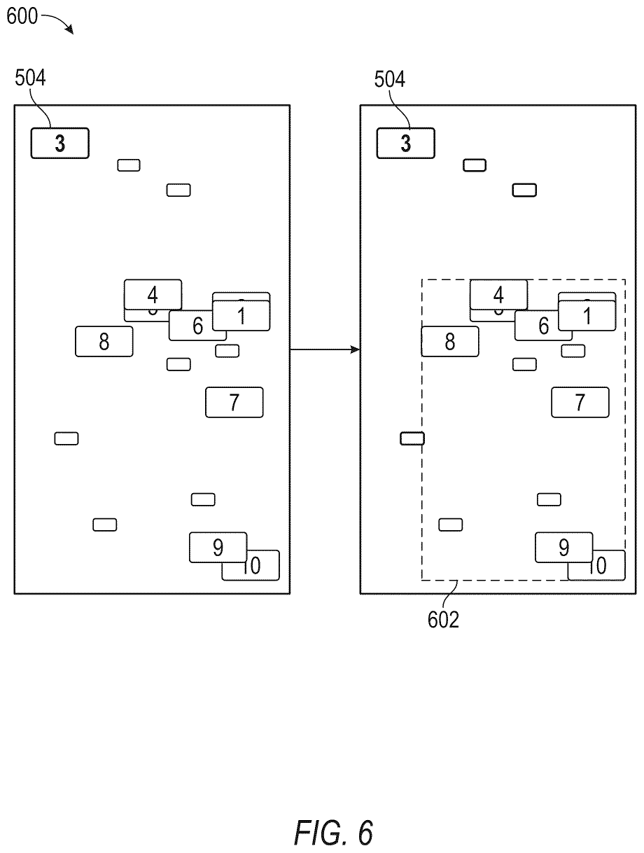

FIG. 6 illustrates an example 600 showing a farthest listing 3 (504) in the viewport representation from FIG. 5 and then a new bound 602 is fit to the remaining set of candidate listings without the removed listing 3 (504). In the example 600, three mini-pins are also excluded from the new bound 602, since the new bound is fitted to the listings represented by the remaining price pins (1-2 and 4-10).

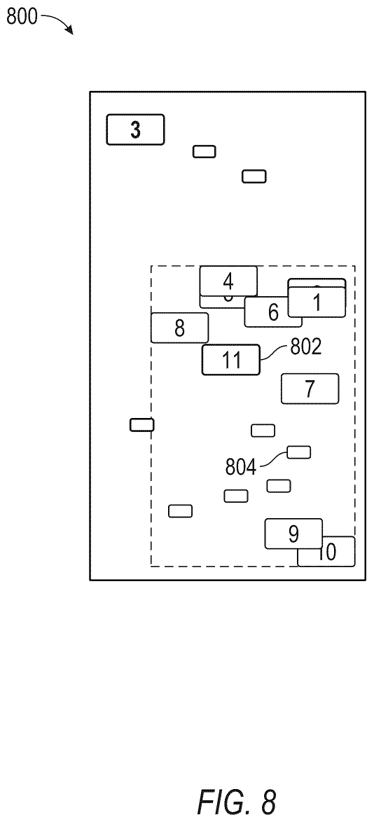

The computing system replaces the removed listing with a new listing that has a geographic location within the new bound for the maps viewport to generate an updated set of candidate listings that include the remaining set of candidate listings and the new listing. In this way, the total number of listings can be maintained. The new listing can be selected based on a listing that has a highest booking probability of a plurality of available listings for the geographical area that are not yet included in the remaining set of candidate listings. FIG. 8 illustrates an example 800 where the removed listing is replaced by a new listing 11 (802). The example 800 further illustrates how the three mini-pins are also replaced with three new mini-pins, such as mini-pin 804. In this example where mini-pins are included, the computing system determines that one or more mini-pins representing lower relevant listings in the geographical area are outside of the new bound of the maps viewport and replaces the one or more lower relevant listings with new lower relevant listings that are within the new bound for the maps viewport to be displayed in the map viewport in the user interface of the computing device of a set of listings that has the maximum score, as explained below.

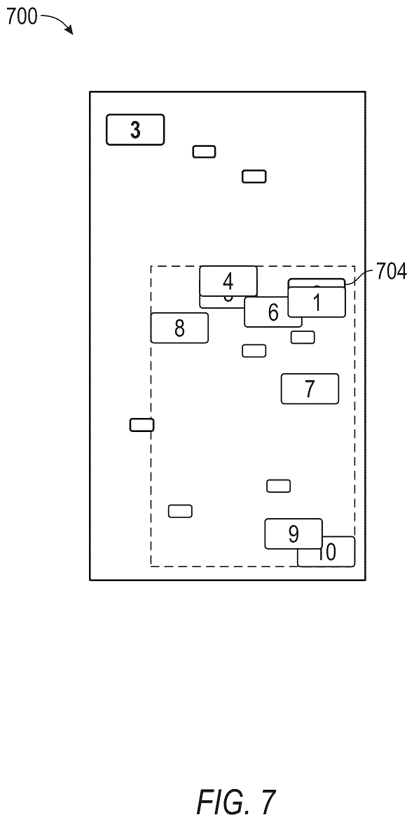

As an optional operation, the computing system can remove any listings that are overlapped by other listings. FIG. 7 illustrates an example 700 where one listing 704 is overlapped by listing 1. In this optional step, the computing system determines that the listing 704 is overlapped, removes the listing 704 and replaces the removed listing 704 with a second new listing, as described above, to generate the updated set of candidate listings that includes the remaining set of candidate listings (without the farthest listing 3 (504) and the overlapped listing 704), and the new listing and the second new listing. In the example 700 only one listing is overlapped, it is to be understood that more than one listing can be overlapped, removed, and replaced in other examples. For example, the computing system determines one or more listings in the remaining set of candidate listings is overlapped by another listing, removes the one or more listing form the remaining set of candidate listings, and replaces each of the removed listings with a listing that has a geographical location within the new bound for the maps viewport to generate the updated set of candidate listings.

The computing system calculates a cumulative booking score for the updated set of candidate listings, as described above for the initially selected set of candidate listings. The computing system determines whether the cumulative booking score for the updated set of listings is greater than the maximum score, indicating that it is a better option that the initially selected set of candidate listings. Based on determining that the new cumulative booking score for the updated set of candidate listings is greater than the maximum score, the computing system sets the maximum score to the new cumulative booking score. If the computing system determines that the new cumulative booking score for the updated set of candidate listings is less than the maximum score, the computing system maintains the same maximum score.

The computing system can perform the operations from determining and removing a farthest listing for up to a predefined number of listings (e.g., 1, 3, 5). As an example, a maximum of 3 is used to describe these operations further. The computing system would again find a farthest listing in the updated set of candidate listings (e.g. listing 10), remove the listing, fit a new bounding box to the remaining listings, replace the removed listing, (optionally remove any overlapped listings), and calculate a cumulative booking score for the updated set of candidate listings, as described above. If the new cumulative score is greater that the maximum score, the computing system sets the maximum score to the new cumulative booking score. If the computing system determines that the new cumulative booking score for the updated set of candidate listings is less than the maximum score, the computing system maintains the same maximum score. As also explained above. And this is again repeated a third time since the maximum is 3 in this example.

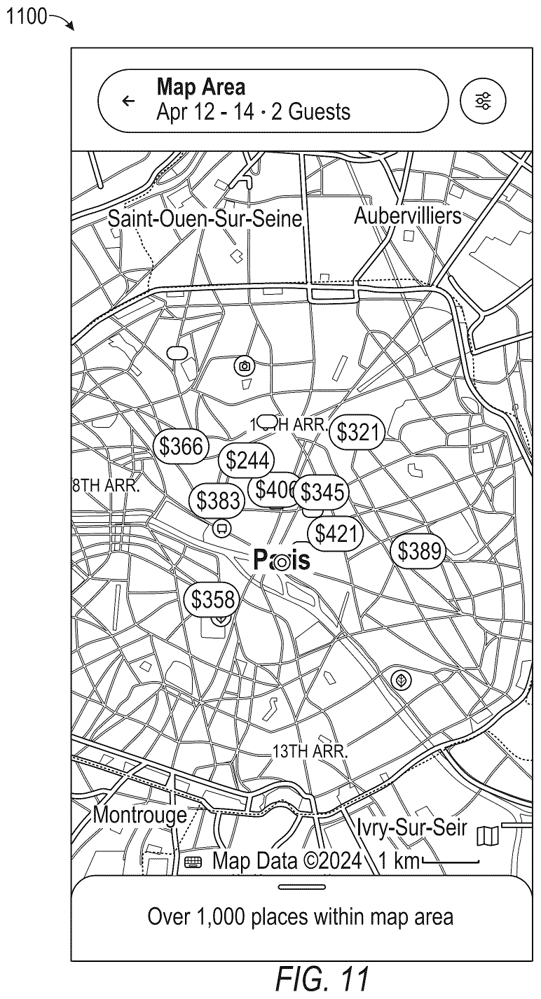

In operation 412, the computing system causes display in the map viewport on the user interface of the computing device, a set of listings that has the maximum score. The set of listings that has the maximum score can be the initially selected set of candidate listings or one of the updated set of candidate listings from above, that has the maximum score. In one example, the computing system adjusts the bound of the maps viewport according to a map area width/height ratio of the display of the computing device (e.g., based on the computing device screen size). FIG. 11 illustrates an example display 1100 in a map viewport on a user interface of a computing device of the set of listings that have the maximum score.

In the examples described above that also include mini-pins, only price pins are used for optimization. In other examples, both price pins and mini-pins are used for optimization.

In some examples, before causing display of the set of listings that has the maximum score, the computing system optionally evaluates various shifts of the center of the maps viewport to determine an optimal center. For example, the computing system generates a list of candidate map centers by dividing the new bound for the maps viewport into grids and using each intersection of the grids as a candidate for a map center and traverses the list of candidate map centers to determine an optimized map center based on a candidate map center with a highest cumulative booking score. The computing device causes display in the map viewport in the user interface of the computing device of a set of listings that has the maximum score and with the optimized map center. In this way, the most bookable listings of the set of listings are in the center of the maps viewport.

Accordingly, a maps viewport optimization system is described that dynamically customizes, in real time or near real time (e.g., in milliseconds in response to a request to view listings or to a zoom or drag of a map viewport) how listings are displayed in a maps viewport to improve the quality and visibility of listings shown in a map format to address at least the above-described technical problems. Optimizing the distribution of listings displayed in a maps viewport further increases bookings for location searches.

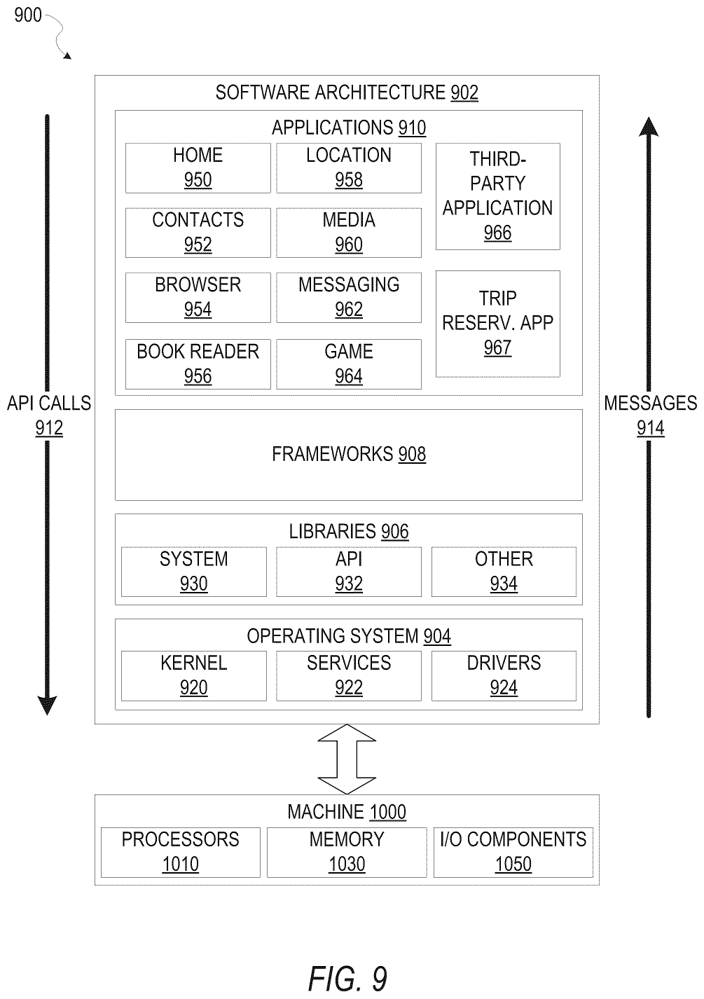

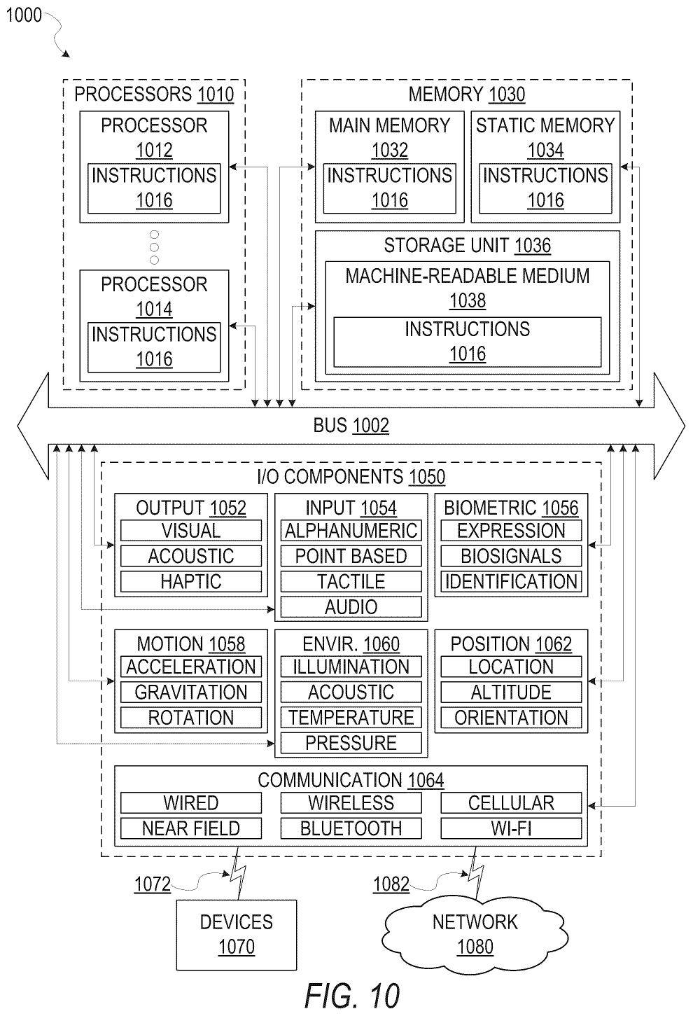

FIG. 9 is a block diagram 900 illustrating a software architecture 902, which can be installed on any one or more of the devices described above. For example, in various embodiments, the client device 110 and server systems 130, 102, 120, 122, and 124 may be implemented using some or all of the elements of the software architecture 902. FIG. 9 is merely a nonlimiting example of a software architecture, and it will be appreciated that many other architectures can be implemented to facilitate the functionality described herein. In various embodiments, the software architecture 902 is implemented by hardware such as a machine 1000 of FIG. 10 that includes processors 1010, memory 1030, and input/output (I/O) components 1050. In this example, the software architecture 902 can be conceptualized as a stack of layers where each layer may provide a particular functionality. For example, the software architecture 902 includes layers such as an operating system 904, libraries 906, frameworks 908, and applications 910. Operationally, the applications 910 invoke API calls 912 through the software stack and receive messages 914 in response to the API calls 912, consistent with some embodiments.

In various implementations, the operating system 904 manages hardware resources and provides common services. The operating system 904 includes, for example, a kernel 920, services 922, and drivers 924. The kernel 920 acts as an abstraction layer between the hardware and the other software layers, consistent with some embodiments. For example, the kernel 920 provides memory management, processor management (e.g., scheduling), component management, networking, and security settings, among other functionalities. The services 922 can provide other common services for the other software layers. The drivers 924 are responsible for controlling or interfacing with the underlying hardware, according to some embodiments. For instance, the drivers 924 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

In some embodiments, the libraries 906 provide a low-level common infrastructure utilized by the applications 910. The libraries 906 can include system libraries 930 (e.g., C standard library) that can provide functions such as memory allocation functions, string manipulation functions, mathematic functions, and the like. In addition, the libraries 906 can include API libraries 932 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render graphic content in two dimensions (2D) and in three dimensions (3D) on a display), database libraries (e.g., SQLite to provide various relational database functions), web libraries (e.g., WebKit to provide web browsing functionality), and the like. The libraries 906 can also include a wide variety of other libraries 934 to provide many other APIs to the applications 910.

The frameworks 908 provide a high-level common infrastructure that can be utilized by the applications 910, according to some embodiments. For example, the frameworks 908 provide various graphic user interface (GUI) functions, high-level resource management, high-level location services, and so forth. The frameworks 908 can provide a broad spectrum of other APIs that can be utilized by the applications 910, some of which may be specific to a particular operating system 904 or platform.

In an example embodiment, the applications 910 include a home application 950, a contacts application 952, a browser application 954, a book reader application 956, a location application 958, a media application 960, a messaging application 962, a game application 964, and a broad assortment of other applications, such as a third-party application 966. According to some embodiments, the applications 910 are programs that execute functions defined in the programs. Various programming languages can be employed to create one or more of the applications 910, structured in a variety of manners, such as object-oriented programming languages (e.g., Objective-C, Java, C++) or procedural programming languages (e.g., C or assembly language). In a specific example, the third-party application 966 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 966 can invoke the API calls 912 provided by the operating system 904 to facilitate functionality described herein.

Some embodiments may particularly include a trip reservation application 967, which may be any application that requests data or other tasks to be performed by systems and servers described herein, such as the server system 102, third-party servers 130, and so forth. In certain embodiments, this may be a standalone application that operates to manage communications with a server system such as the third-party servers 130 or server system 102. In other embodiments, this functionality may be integrated with another application. The trip reservation application 1067 may request and display various data related to an online marketplace and may provide the capability for a user 106 to input data related to the system via voice, a touch interface, or a keyboard, or using a camera device of the machine 1000, communication with a server system via the I/O components 1050, and receipt and storage of object data in the memory 1030. Presentation of information and user inputs associated with the information may be managed by the trip reservation application 967 using different frameworks 908, library 906 elements, or operating system 904 elements operating on a machine 1000.

FIG. 10 is a block diagram illustrating components of a machine 1000, according to some embodiments, able to read instructions from a machine-readable medium (e.g., a machine-readable storage medium) and perform any one or more of the methodologies discussed herein. Specifically, FIG. 10 shows a diagrammatic representation of the machine 1000 in the example form of a computer system, within which instructions 1016 (e.g., software, a program, an application 910, an applet, an app, or other executable code) for causing the machine 1000 to perform any one or more of the methodologies discussed herein can be executed. In alternative embodiments, the machine 1000 operates as a standalone device or can be coupled (e.g., networked) to other machines. In a networked deployment, the machine 1000 may operate in the capacity of a server system 130, 102, 120, 122, 124, and the like, or a client device 110 in a server-client network environment, or as a peer machine in a peer-to-peer (or distributed) network environment. The machine 1000 can comprise, but not be limited to, a server computer, a client computer, a personal computer (PC), a tablet computer, a laptop computer, a netbook, a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1016, sequentially or otherwise, that specify actions to be taken by the machine 1000. Further, while only a single machine 1000 is illustrated, the term “machine” shall also be taken to include a collection of machines 1000 that individually or jointly execute the instructions 1016 to perform any one or more of the methodologies discussed herein.

In various embodiments, the machine 1000 comprises processors 1010, memory 1030, and I/O components 1050, which can be configured to communicate with each other via a bus 1002. In an example embodiment, the processors 1010 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) include, for example, a processor 1012 and a processor 1014 that may execute the instructions 1016. The term “processor” is intended to include multi-core processors 1010 that may comprise two or more independent processors 1012, 1014 (also referred to as “cores”) that can execute instructions 1016 contemporaneously. Although FIG. 10 shows multiple processors 1010, the machine 1000 may include a single processor 1010 with a single core, a single processor 1010 with multiple cores (e.g., a multi-core processor 1010), multiple processors 1012, 1014 with a single core, multiple processors 1012, 1014 with multiple cores, or any combination thereof.

The memory 1030 comprises a main memory 1032, a static memory 1034, and a storage unit 1036 accessible to the processors 1010 via the bus 1002, according to some embodiments. The storage unit 1036 can include a machine-readable medium 1038 on which are stored the instructions 1016 embodying any one or more of the methodologies or functions described herein. The instructions 1016 can also reside, completely or at least partially, within the main memory 1032, within the static memory 1034, within at least one of the processors 1010 (e.g., within the processor's cache memory), or any suitable combination thereof, during execution thereof by the machine 1000. Accordingly, in various embodiments, the main memory 1032, the static memory 1034, and the processors 1010 are considered machine-readable media 1038.

As used herein, the term “memory” refers to a machine-readable medium 1038 able to store data temporarily or permanently and may be taken to include, but not be limited to, random-access memory (RAM), read-only memory (ROM), buffer memory, flash memory, and cache memory. While the machine-readable medium 1038 is shown, in an example embodiment, to be a single medium, the term “machine-readable medium” should be taken to include a single medium or multiple media (e.g., a centralized or distributed database, or associated caches and servers) able to store the instructions 1016. The term “machine-readable medium” shall also be taken to include any medium, or combination of multiple media, that is capable of storing instructions (e.g., instructions 1016) for execution by a machine (e.g., machine 1000), such that the instructions 1016, when executed by one or more processors of the machine 1000 (e.g., processors 1010), cause the machine 1000 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory (e.g., flash memory), an optical medium, a magnetic medium, other nonvolatile memory (e.g., erasable programmable read-only memory (EPROM)), or any suitable combination thereof. The term “machine-readable medium” specifically excludes nonstatutory signals per se.

The I/O components 1050 include a wide variety of components to receive input, provide output, produce output, transmit information, exchange information, capture measurements, and so on. In general, it will be appreciated that the I/O components 1050 can include many other components that are not shown in FIG. 10. The I/O components 1050 are grouped according to functionality merely for simplifying the following discussion, and the grouping is in no way limiting. In various example embodiments, the I/O components 1050 include output components 1052 and input components 1054. The output components 1052 include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor), other signal generators, and so forth. The input components 1054 include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

In some further example embodiments, the I/O components 1050 include biometric components 1056, motion components 1058, environmental components 1060, or position components 1062, among a wide array of other components. For example, the biometric components 1056 include components to detect expressions (e.g., hand expressions, facial expressions, vocal expressions, body gestures, eye tracking), measure biosignals (e.g., blood pressure, heart rate, body temperature, perspiration, brain waves), identify a person (e.g., voice identification, retinal identification, facial identification, fingerprint identification, electroencephalogram-based identification), and the like. The motion components 1058 include acceleration sensor components (e.g., accelerometer), gravitation sensor components, rotation sensor components (e.g., gyroscope), and so forth. The environmental components 1060 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensor components (e.g., machine olfaction detection sensors, gas detection sensors to detect concentrations of hazardous gases for safety or to measure pollutants in the atmosphere), or other components that may provide indications, measurements, or signals corresponding to a surrounding physical environment. The position components 1062 include location sensor components (e.g., a GPS receiver component), altitude sensor components (e.g., altimeters or barometers that detect air pressure from which altitude may be derived), orientation sensor components (e.g., magnetometers), and the like.

Communication can be implemented using a wide variety of technologies. The I/O components 1050 may include communication components 1064 operable to couple the machine 1000 to a network 1080 or devices 1070 via a coupling 1082 and a coupling 1072, respectively. For example, the communication components 1064 include a network interface component or another suitable device to interface with the network 1080. In further examples, communication components 1064 include wired communication components, wireless communication components, cellular communication components, near field communication (NFC) components, BLUETOOTH® components (e.g., BLUETOOTH® Low Energy), WI-FI® components, and other communication components to provide communication via other modalities. The devices 1070 may be another machine 1000 or any of a wide variety of peripheral devices (e.g., a peripheral device coupled via a USB).

Moreover, in some embodiments, the communication components 1064 detect identifiers or include components operable to detect identifiers. For example, the communication components 1064 include radio frequency identification (RFID) tag reader components, NFC smart tag detection components, optical reader components (e.g., an optical sensor to detect one-dimensional bar codes such as a Universal Product Code (UPC) bar code, multidimensional bar codes such as a Quick Response (QR) code, Aztec Code, Data Matrix, Dataglyph, MaxiCode, PDF417, Ultra Code, Uniform Commercial Code Reduced Space Symbology (UCC RSS)-2D bar codes, and other optical codes), acoustic detection components (e.g., microphones to identify tagged audio signals), or any suitable combination thereof. In addition, a variety of information can be derived via the communication components 1064, such as location via Internet Protocol (IP) geo-location, location via WI-FI® signal triangulation, location via detecting a BLUETOOTH® or NFC beacon signal that may indicate a particular location, and so forth.

In various example embodiments, one or more portions of the network 1080 can be an ad hoc network, an intranet, an extranet, a VPN, a LAN, a WLAN, a WAN, a WWAN, a MAN, the internet, a portion of the internet, a portion of the PSTN, a plain old telephone service (POTS) network, a cellular telephone network, a wireless network, a WI-FI® network, another type of network, or a combination of two or more such networks. For example, the network 1080 or a portion of the network 1080 may include a wireless or cellular network, and the coupling 1082 may be a Code Division Multiple Access (CDMA) connection, a Global System for Mobile (GSM) communications connection, or another type of cellular or wireless coupling. In this example, the coupling 1082 can implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

In example embodiments, the instructions 1016 are transmitted or received over the network 1080 using a transmission medium via a network interface device (e.g., a network interface component included in the communication components 1064) and utilizing any one of a number of well-known transfer protocols (e.g., HTTP). Similarly, in other example embodiments, the instructions 1016 are transmitted or received using a transmission medium via the coupling 1072 (e.g., peer-to-peer coupling) to the devices 1070. The term “transmission medium” shall be taken to include any intangible medium that is capable of storing, encoding, or carrying the instructions 1016 for execution by the machine 1000, and includes digital or analog communications signals or other intangible media to facilitate communication of such software.

Furthermore, the machine-readable medium 1038 is nontransitory (in other words, not having any transitory signals) in that it does not embody a propagating signal. However, labeling the machine-readable medium 1038 “nontransitory” should not be construed to mean that the medium is incapable of movement; the machine-readable medium 1038 should be considered as being transportable from one physical location to another. Additionally, since the machine-readable medium 1038 is tangible, the machine-readable medium 1038 may be considered to be a machine-readable device.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, components, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A computer-implemented method, comprising:
generating a maximum score for a set of candidate listings based on a booking probability for each listing, a distance of each listing location from a center of a bound for a maps viewport, and visibility based on other listings;
optimizing listings to be shown in the maps viewport by performing, for a maximum of a predefined number of listings removed, operations comprising:
removing, from the set of candidate listings, a listing with a largest distance to all other listings;
fitting a new bound for the maps viewport that includes a remaining set of candidate listings without the removed listing;
replacing the removed listing with a new listing that has a geographical location within the new bound for the maps viewport to generate an updated set of candidate listings that includes the remaining set of candidate listings and the new listing;
calculating a cumulative booking score for the updated set of candidate listings;
determining whether the cumulative booking score for the updated set of candidate listings is greater than the maximum score; and
based on determining that the cumulative booking score for the updated set of candidate listings is greater than the maximum score, setting the maximum score to the cumulative booking score; and
causing display of a set of listings that has the maximum score in the maps viewport in a user interface of a computing device.

2. The computer-implemented method of claim 1, wherein each listing is represented by a graphical icon in the maps viewport.

3. The computer-implemented method of claim 2, wherein in the graphical icon is a graphical icon of a first size and the maps viewport further includes a display of a plurality of graphical icons of a second size, representing lower relevance listings in a geographical area represented in the maps viewport.

4. The computer-implemented method of claim 3, wherein the operations for optimizing the listings to be shown in the maps viewport further comprise:
determining that one or more graphical icons of the second size representing lower relevant listings in the geographical area are outside of the new bound for the maps viewport; and
replacing the one or more lower relevant listings with new lower relevant listings within the new bound for the maps viewport to be displayed in the map viewport in the user interface of the computing device of a set of listings that has the maximum score.

5. The computer-implemented method of claim 1, the operations for optimizing the listings to be shown in the maps viewport further comprise:
determining one or more listings in the remaining set of candidate listings is overlapped by another listing;
removing the one or more listings from the remaining set of candidate listings; and
replacing each of the removed one or more listings with a listing that has a geographical location within the new bound for the maps viewport to generate the updated set of candidate listings.

6. The computer-implemented method of claim 1, further comprising:
generating a list of candidate map centers by dividing the new bound for the maps viewport into grids and using each intersection of the grids as a candidate for a map center; and
traversing the list of candidate map centers to determine an optimized map center based on a candidate map center with a highest cumulative booking score;
wherein causing display in the maps viewport in the user interface of the computing device of a set of listings that has the maximum score includes display of the set of listings with the optimized map center.

7. The computer-implemented method of claim 1, wherein set of candidate listings comprise a top predefined number of listings from a plurality of listings having geographic locations within a geographical area and the top predefined number of listings comprise listings with a high booking probability.

8. The computer-implemented method of claim 1, wherein the cumulative booking score for the updated set of candidate listings is calculated based on a booking probability for each listing, a distance of the listing from a center of the new bound for the maps viewport, and visibility based on other listings.

9. A computing system comprising:
a memory that stores instructions; and
one or more processors configured by the instructions to perform operations comprising:
generating a maximum score for a set of candidate listings based on a booking probability for each listing, a distance of each listing location from a center of a bound for a maps viewport, and visibility based on other listings;
optimizing listings to be shown in the maps viewport by performing, for a maximum of a predefined number of listings removed, operations comprising:
removing, from the set of candidate listings, a listing with a largest distance to all other listings;
fitting a new bound for the maps viewport that includes a remaining set of candidate listings without the removed listing;
replacing the removed listing with a new listing that has a geographical location within the new bound for the maps viewport to generate an updated set of candidate listings that includes the remaining set of candidate listings and the new listing;
calculating a cumulative booking score for the updated set of candidate listings;
determining whether the cumulative booking score for the updated set of candidate listings is greater than the maximum score; and
based on determining that the cumulative booking score for the updated set of candidate listings is greater than the maximum score, setting the maximum score to the cumulative booking score; and
causing display of a set of listings that has the maximum score in the maps viewport in a user interface of a computing device.

10. The computing system of claim 9, wherein each listing is represented by a graphical icon in the maps viewport.

11. The computing system of claim 10, wherein in the graphical icon is a graphical icon of a first size and the maps viewport further includes a display of a plurality of graphical icons of a second size, representing lower relevance listings in a geographical area represented in the maps viewport.

12. The computing system of claim 11, wherein the operations for optimizing the listings to be shown in the maps viewport further comprise:
determining that one or more graphical icons of the second size representing lower relevant listings in the geographical area are outside of the new bound for the maps viewport; and
replacing the one or more lower relevant listings with new lower relevant listings within the new bound for the maps viewport to be displayed in the map viewport in the user interface of the computing device of a set of listings that has the maximum score.

13. The computing system of claim 9, the operations for optimizing the listings to be shown in the maps viewport further comprising:
determining one or more listings in the remaining set of candidate listings is overlapped by another listings;
removing the one or more listings from the remaining set of candidate listings; and
replacing each of the removed one or more listings with a listing that has a geographical location within the new bound for the maps viewport to generate the updated set of candidate listings.

14. The computing system of claim 9, the operations further comprising:
generating a list of candidate map centers by dividing the new bound for the maps viewport into grids and using each intersection of the grids as a candidate for a map center; and
traversing the list of candidate map centers to determine an optimized map center based on a candidate map center with a highest cumulative booking score;
wherein causing display in the maps viewport in the user interface of the computing device of a set of listings that has the maximum score includes display of the set of listings with the optimized map center.

15. The computing system of claim 9, wherein set of candidate listings comprise a top predefined number of listings from a plurality of listings having geographic locations within a geographical area and the top predefined number of listings comprise listings with a high booking probability.

16. The computing system of claim 9, wherein the cumulative booking score for the updated set of candidate listings is calculated based on a booking probability for each listing, a distance of the listing from a center of the new bound for the maps viewport, and visibility based on other listings.

17. A non-transitory computer-readable medium comprising instructions stored thereon that are executable by at least one processor to cause a computing device to perform operations comprising:
generating a maximum score for a set of candidate listings based on a booking probability for each listing, a distance of each listing location from a center of a bound for a maps viewport, and visibility based on other listings;
optimizing listings to be shown in the maps viewport by performing, for a maximum of a predefined number of listings removed, operations comprising:
removing, from the set of candidate listings, a listing with a largest distance to all other listings;
fitting a new bound for the maps viewport that includes a remaining set of candidate listings without the removed listing;
replacing the removed listing with a new listing that has a geographical location within the new bound for the maps viewport to generate an updated set of candidate listings that includes the remaining set of candidate listings and the new listing;
calculating a cumulative booking score for the updated set of candidate listings;
determining whether the cumulative booking score for the updated set of candidate listings is greater than the maximum score; and
based on determining that the cumulative booking score for the updated set of candidate listings is greater than the maximum score, setting the maximum score to the cumulative booking score; and
causing display of a set of listings that has the maximum score in the maps viewport in a user interface of a computing device.

18. The non-transitory computer-readable medium of claim 17, the operations for optimizing the listings to be shown in the maps viewport further comprise:
determining one or more listings in the remaining set of candidate listings is overlapped by another listing;
removing the one or more listings from the remaining set of candidate listings; and
replacing each of the removed one or more listings with a listing that has a geographical location within the new bound for the maps viewport to generate the updated set of candidate listings.

19. The non-transitory computer-readable medium of claim 17, the operations further comprising:
generating a list of candidate map centers by dividing the new bound for the maps viewport into grids and using each intersection of the grids as a candidate for a map center; and
traversing the list of candidate map centers to determine an optimized map center based on a candidate map center with a highest cumulative booking score;
wherein causing display in the maps viewport in the user interface of the computing device of a set of listings that has the maximum score includes display of the set of listings with the optimized map center.

20. The non-transitory computer-readable medium of claim 17, wherein the cumulative booking score for the updated set of candidate listings is calculated based on a booking probability for each listing, a distance of the listing from a center of the new bound for the maps viewport, and visibility based on other listings.
